(19) United States
(12) Patent Application Publication
(10) Pub. No.: US 2019/0284753 A1
(43) Pub. Date: Sep. 19, 2019

(54) TEXTILE REINFORCEMENT MATERIAL AND METHOD FOR THE PRODUCTION THEREOF

(71) Applicant: TEXTILCORD STEINFORT S.A., Steinfort (LU)

(72) Inventors: Bernhard Müller, Baden (AT); Enrique HERRERO ACERO, Wien (AT); Sara VECCHIATO, Tulln (AT); Georg GÜBITZ, Hart (AT)

(73) Assignee: TEXTILCORD STEINFORT S.A., Steinfort (LU)

(21) Appl. No.: 16/335,398

(22) PCT Filed: Sep. 25, 2017
(86) PCT No.: PCT/EP2017/074222

§ 371 Date: Mar. 21, 2019

(30) Foreign Application Priority Data
Sep. 26, 2016 (DE) 10 2016 011 645.5

(51) Int. Cl. D06M 16/00; D06M 15/693; D02G 3/48; B60C 9/00

(52) U.S. Cl. CPC D06M 16/003; D06M 15/693; D06M 2101/36; B60C 9/0042; D02G 3/48

(57) ABSTRACT

The invention relates to a textile reinforcement material for reinforcing in particular rubber products, having at least one multi-fibre, which has aramid fibres having docking sites in the form of carboxyl groups arranged on the surface thereof for coupling in particular a rubber material, having an areal density of at least 0.2 nmol/mm² and a tensile strength of the multi-fibre of at least 600 MPa.

The invention relates to a textile reinforcement material for reinforcing in particular rubber products, having at least one multi-fibre, which has aramid fibres having docking sites in the form of carboxyl groups arranged on the surface thereof for coupling in particular a rubber material, as well as to a method for the production thereof.

There have been known reinforcement materials having such fibres as well as fibres made from other synthetic polymers like polyamide 6, or polyamide 6.6 or diverse polyesters, in particular polyethylene terephthalate (PET). Such reinforcement materials, whether in the structure of a roving, cord or a flat textile fabric, in particular of a fabric, are, for example, used for reinforcing vehicle tyres, by a resin-latex matrix being applied onto the fibre structures in the course of dipping, which is then thermoset. In this “dried” form, the dipped tyre cord or the tyre cord fabric is embedded in non-vulcanized rubber (e.g., co-extrusion or calandration) and used for producing a green tyre, used for example for the carcass. Resorcinol-formaldehyde latex (RFL) is typically used as a dip, usually in the form of an emulsion of latex in a solution of resorcinol and formaldehyde. Those skilled in the art, however, will also know other dip preparations that are free from formaldehyde and/or resorcinol from literature.

While other fibre structures, e.g. from rayon, create good adhesion to the dip, this adhesion is markedly less pronounced with non-activated polyester and aramid fibres. For this reason, they are provided with an intermediate covering before the standard RFL dip, by being immersed in a pre-dip bath, for example. Such a pre-dip may contain, for instance, a mixture of blocked isocyanates and low molecular epoxides, such as described in the “Handbook of Rubber Bonding”, Bryan Crowther, Rubber Technology Ltd., 2003, p. 246. The surface of the material then is not composed of the fibres themselves anymore but rather of the intermediate covering of the material of the pre-dip. This results in total in significantly better adhesion properties, with the pre-dip having become industrial norm, not least because this approach is superior to other approaches of the aramid fibre activation such as plasma or nitric acid treatment in terms of the process as well as in regard of a controlled uniform surface action. The DE 3485697 T2, for example, describes a coating reagent (dip) for modified aramid fibres in order to improve the adhesion properties.

The invention is based on the problem to further develop textile reinforcement materials of the initially mentioned type in a way such that, on the one side, there will be ensured the applicability thereof also with high mechanical requirements such as in tyre cord applications and, on the other side, additionally these can be produced using a simple and comparably universally applicable technology.

This aim is solved by a textile reinforcement material of the initially mentioned type, which is characterized by an areal density of the docking sites of at least 0.2 nmol/mm² and a tensile strength of the multi-fibre of at least 600 MPa.

The inventors have found that aramid fibres, which are characterized by an areal density of the docking sites of at least 0.2 nmol/mm², may be provided in a method according to the invention using oxidoreductases, without any loss of mechanical properties such as, e.g., tensile strength.

The use of enzymes for the modification of textile fibres is described, for example, in WO 2005/121438 A2 for polyamides, aiming at the improvement of deying characteristics. The non-aromatic amide fibres (nylon) investigated therein could be modified using proteases. The inventors of the present application have found that transfer of the concept of modification described in WO 2005/121438 A2 to aramids is not possible (see comparative examples; table 1a).

Surprisingly, it has been possible, however, to selectively increase the docking sites using oxidoreductases, e.g., laccases. Laccases are described, for example, in the context of modification of polymer characteristics also in WO 2010/0116041 and mentioned also in WO 2005/121438 A2. In connection with aramids, the use of laccases has not been disclosed so far.

The fibre structures according to the invention thus are characterized in that the areal density of the docking sites is significantly higher than the areal density existing in standard commercially available aramid fibres (about 0.11 nmol/mm²), wherein simultaneously the structural integrity of the aramid fibres bears comparison to standard aramid fibres and thus also the mechanical properties such as tensile strength.

The docking sites, in this regard, relate to the directly accessible fibre surface of the aramid fibre, i.e. not on a covering applied to the surface thereof, such as by way of a pre-dip. The areal density, in this regard, relates to the surface proportion of the reinforcement material, occupied by the aramid fibres. This means, if the reinforcement material consisted of aramid fibres such as in a possible embodiment, then the surface that is coupled would be the reference, with, e.g., hybrids it would be the corresponding surface proportion of the aramid fibres.

Due to the high areal density of the docking sites according to the invention, adhesion of the fibre structure to, e.g., a resin-latex matrix or a rubber matrix, is significantly improved, thus obtaining the advantage that the pre-dip may be omitted in the production of, for example, a tyre cord.

Especially preferably, the areal density of the docking sites is at least 0.4 nmol/mm², in particular at least 0.6 nmol/mm². This will again increase the adhesive strength of the aramid fibres or the structure, in which they form the reinforcement material, respectively.

In a further preferred embodiment the areal density of the docking sites is at the most 2.4 nmol/mm², in particular at the most 2.0 nmol/mm², even at the most 1.6 nmol/mm².

In this way, a structural integrity of the fibres will be ensured. Radical chemical treatments of the aramid fibre surfaces could possible create a very high number of chain ends by way of a radical chain destruction, but rather with a degenerative effect down to the deeper layers of the fibres, thus destroying tensile strength.

This tensile strength is maintained with the fibres of the reinforcement material according to the invention and is preferably even at least 800 MPa, further preferred at least 1000 MPa, in particular at least 1200 MPa. There could be obtained, however, also higher values such as 1800 MPa or more, up to 3000 MPa or more, in particular if the multi-fibre is composed predominantly or completely of aramid fibres. Yards, which are also commercially available herefore, could serve as aramid fibres, such as, e.g., Kevlar® or Twaron®. The tensile strength values relate to the conditioned state according to ASTM D885-85.

In a preferred embodiment the water drop absorption time, which may be determined, for example, using the WCA test, is less than 1.6 seconds, in particular less than 1.2 seconds, even less than 0.8 seconds. As will be explained further below, the absorption time may then be as short such that even the angle measurement aimed at using the WCA test will not be reasonably feasible anymore.

A part of the docking sites is preferably formed from disrupted former amide bonds of the fibres.

In an especially preferred embodiment a predominant part of the docking sites is generated by a surface treatment of the fibre structure including disrupting amide bonds of the amide fibres that are near to the surface under the effect of an oxidoreductase, in particular a laccase (EC 1.10.3.2). This generation will ensure a gentle generation, by way of which a degenerative disintegration of the fibres in regions that are remote from the surface will be omitted and the structural integrity of the fibres will be impaired at most undetectable. For example, the copper cores of the laccase will represent the electron acceptor side in their oxidizing cycle. As a further variant, also peroxidases could be considered as oxidoreductase.

In this connection, there is preferably provided a disconnecting mechanism for disrupting the amide bonds, which includes disrupting agents alternating cyclically between at least two different adopted states, wherein this cyclic change of state is driven in a partial cycle by the oxidoreductase and in another partial cycle, respectively, the disrupting agents interact in an energy transferring way with the aramid fibresnear an amide bond and/or C₆ ring (aromatic segment). The aramid fibre is thereby oxidized, wherein at least a part of the docking sites is generated from the amide bonds thus disrupted. In this way, the surface density of the docking sites is provided especially effectively; the disrupting agents acting, metaphorically speaking, as shuttles (or mediator between the fibre structure and the laccase) in order to cyclically absorb energy and emit it locally to the bonds to be disrupted or as a mediator for the electron transfer involved with the oxidation of the aramides, respectively.

In an especially preferred embodiment the reinforcement material comprises a rubber matrix having a fibre structure containing aramid fibres embedded therein. In this way, the reinforcement material thus coated may be tyre cord or a tyre cord fabric, and the coating/rubber matrix may result from the RFL dip explained above. There is, however, more generally contemplated a reinforcement material in the form of a composite, the matrix of which binds to these docking sites of the textile structure described so far above with the multi-fibre containing the aramid fibres. In the context of the invention, the textile structure may have one or several twisted or un-twisted multi-fibres, or it may be present as cord (single-end cord) or also as a roving, a woven fabric, a knitted fabric or a warp-knitted fabric.

A reinforcement material such coated, in particular a tyre cord or a flat tyre cord construction, has especially preferably a pull of at least 92 N/cm, in particular at least 96 N/cm, even at least 100 N/cm, which is determined according to ASTM D4393.

The fibre structure of the textile reinforcement material could also be formed exclusively from aramid fibres, which is, however, not limited thereto. There could also be contained fibre components made from non-aramid fibres such as, e.g., polyamide 66, or other synthetic fibre components such as polyester or rayon. More particularly, there is considered to be advantageous in particular a hybrid structure, aramid-nylon.

The reinforcement material according to the invention may be used in various applications in order to reinforce in particular rubber products or products having rubber materials, in particular contemplating the reinforcement of rubber products such as charcass and belt bandage material for tyres, in particular vehicle tyres, but also of belt conveyors or hoses. These uses are also claimed as correspondingly reinforced rubber products, in particular tyres.

In regard to process technology, there is provided a method for preparing a structure containing fibres for the coupling thereof in particular to a rubber matrix, wherein the fibres have linear arrangements with at least in part aromatic segments, which are connected to one another respectively via amide bonds, which is characterized essentially by the fact that at the surface of the fibres amide bonds are disrupted by a disruption mechanism including an oxidoreductase, in particular laccase, and that, thus, docking sites for the coupling of in particular the rubber matrix are generated from the disrupted amide bonds.

The particular advantage of the method according to the invention lies in the gentle effect of the disurpting mechanism, as in this way amide bonds that are near to the fibre surface will be disrupted in a careful way primarily completely limited to the fibre surfaces such that the free ends developing in this way will constitute docking sites for coupling of, for example, the rubber matrix. The fibre main body remains de facto unaffected, wherein there may be used scanning electron microscopic images for the assessment of this criteria. Accordingly, the good mechanical properties of the fibres, in particular the tensile strength properties, will be maintained and not sacrificed for an improved adhesiveness.

The separating mechanism has preferably disrupting agents cyclically alternating between at least two different adopted states, wherein this cyclic change in state is driven in a partial cycle by the oxidoreductase and wherein in another partial cycle, respectively, the disrupting agents interact in an energy transferring way with the fibre near an amide bond and/or C₆ ring. Using this further development, the disruption mechanism is further improved and targeted.

The disrupting agents preferably comprise in at least one of the cyclically adopted states nitroxyl radicals and/or oxo-ammonium ions.

In an especially preferred embodiment the disrupting agents are formed from one or several substances comprised in the group of HBT (1-hydroxybenzotriazol), VLA (violuric acid) and TEMPO (2,2,6,6-tetramethylpiperidinyloxyl). These substances are in particular suitable to act as disrupting agents, on the one side, and to re-adopt the state, in which they may act in a disrupting way, by reaction with the oxidoreductase. The mode of action is a hydrogen atom transfer (HBT, VLA) or an ionic oxidation mechanism (TEMPO). Similarly, also substances such as N-hydroxyacetanilide (NHA) or N-hydroxyphtalamide (HPI) could be used as disrupting agents.

As already explained above, it is important to retain an in particular as uniform as possible structural integrity of the fibre bodies. In particular in the context of gentle treatment, excessive weakening of the structure of the fibre is to be counteracted. Using proteases has proven to be less suitable in this regard. For this reason, there is preferred that the disruption is realized in the absence of proteases.

In a useful embodiment the disruption is realized in an aqueous solution. When docking sites are being formed, there is, hence, present H₂O, which may contribute to the formation of docking sites and is consumed in a corresponding amount in the method.

In this way, there are appropriately obtained fibre-containing structures, wherein the fibres have linear arrangements with at least in part aromatic segments, which are respectively connected to one another via amide bonds, having additional coupling sites generated through the method for coupling the structure to a material to be coupled, in particular a rubber matrix. This might also be result of the RFL dip.

Further details, features and advantages of the invention will become obvious from the subsequent description in relation to the FIGURES attached.

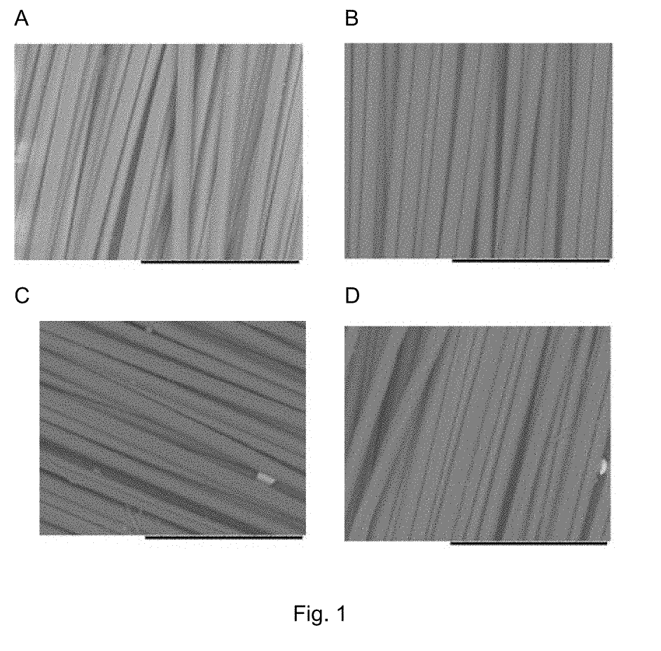

FIG. 1 shows scanning electron microscopic images of untreated (FIG. A) or differently treated fibre structures (FIG. B, C, D), respectively, wherein the scale bar represents respectively 100 μm and wherein the treated fibre structures have been treated with ThL laccase and the disruption agents HBT (FIG. B), TEMPO (FIG. C) or VLA (FIG. D), respectively, as described below.

Firstly, the efficacy of the invention is explained in regard to the provision of an increased amount of carboxyl groups on the surface of a fibre structure of a reinforcement material. As comparative example, the fibres were also incubated with the cysteine protease papain, which was described in WO 2005/121438 as suitable for the provision of increased amounts of carboxyl groups of non-aromatic polyamide fibres.

For the experiments, there were cut sample pieces from aramid fabrics into pieces having a size of 20 mm×20 mm to serve as test samples. As aramid yarn for this fabric, there was used the aramid Twaron T1014 yarn. Before incubation for the surface treatment of the fibre structure, there was carried out a washing step in order to remove possible surface contaminations, in a first step using Triton X-100 (5 gL⁻¹), in a second step using a 100 mM (millimol per litre) Na₂CO₃ solution, and subsequently with double-distilled water (ddH₂O). These steps were carried out for 30 minutes at 50° C. and 130 rpm, and then the samples were placed into a buffer solution (100 mM succinate) following air-drying.

For a zero reference, there was first determined the areal density of the carboxyl groups of an otherwise untreated test sample fibre structure using the Toluidine Blue O (TBO) method (see S. Roediger et al Anal. Chem. vol. 83, pp. 3379-3385, 2011). For this purpose, about 1 g of the sample to be tested were incubated in a 0.1% TBO solution in Tris/HCL buffer (100 mM, pH 8.6) for 15 minutes at 50° C. and 130 rpm (8 mL), removed from the TBO solution and washed with Tris/HCL (100 mM, pH 8.6) until the wash solution became clear. The sample containing TBO was then stirred with 20% SDS for 30 minutes at 50° C. and 130 rpm in order to release the TBA adhering to the carboxyls. From these, the extinction at 625 mM and 23° C. was measured (using spectrophotometry with TECAN Infinite M200PRO).

The degree of carboxylation (DoC) representing the areal density of the docking sites in nmol/mm² was then measured according to the following formula:

DoC=(A·V)/(As·d·ε),

wherein
A: absorption at 625 nm;
V: volume of the desorption solution [L];
Aₛ: surface [mm²] (in the case of cords, the area of the rotary cylinder circulating the cord with the diameter of the cord was used).
d: optical path [cm];
ε: extinction coefficient of TBO [=54800 L mol⁻¹ cm⁻¹];
DoC: degree of carboxylation [nmol/mm²]

As already explained above, for Aₛ there is to be used the areal proportion of the material, which may be deduced from the aramid proportion of the surface, e.g. a proportion of 25% in the case of a cord made from 75% polyester and 25% aromatic polyamide with single fibres, which have previously been twisted together.

In the result, there was obtained a value of 0.11 nmol/mm² for the zero reference.

For the comparative examples, there was used papain (Carica papaya) at different concentrations, wherein the protease activity was given with 3.1 U/mg. The buffer solution for the comparative example was composed of a phosphate buffer (50 mM sodium phosphate, pH 6-7) with EDTA (1 mM) and L-cysteine (5 mM) for the stabilization of the papain. The fibre structure was incubated for 24 hours (temperature 30° C. or 50° C., respectively, 130 rpm). After incubation, there was again carried out a washing step, as already described above.

The results in regard to the degree of carboxylation are presented for the comparative examples in table 1a.

| Sample | DoC (nmol/mm²), TBO method |
|---|---|
| Zero-Reference | 0.11 |
| Comparative Example 1 | 0.08 |
| Incubation at 30° C. without papain | |
| Comparative Example 2 | 0.07 |
| Incubation at 30° C. with papain 180 | |
| U/mg | |
| Comparative Example 3 | 0.07 |
| Incubation at 30° C. with papain 40 | |
| U/mg | |
| Comparative Example 4 | 0.08 |
| Incubation at 50° C. without papain | |
| Comparative Example 5 | 0.08 |
| Incubation at 50° C. with papain 180 | |
| U/mg | |
| Comparative Example 6 | 0.08 |
| Incubation at 50° C. with papain 40 | |
| U/mg | |
| Comparative Example 7 | 0.12 |
| Incubation at 50° C. without papain | |
| Comparative Example 8 | 0.11 |
| Incubation at 50° C. with papain 6 | |
| U/mg | |
| Comparative Example 9 | 0.11 |
| Incubation at 50° C. with papain 0.06 | |
| U/mg | |

It is obvious that no increase of the carboxyl group density is obtained with the aramid fibres, irrespective of the amount of papain concentration used or of the incubation temperature. The observations confirm that the method disclosed in WO 2005/121438 is not feasible using aromatic polyamides. Without wishing to be bound by this theory, there is assumed that proteases, the initial catalytic activity of which is aimed at cleaving amide bonds in peptides or proteins, are not able to attack the amide structures of the aramids, as the amide bond does form a conjugated system with the neighbouring aromatics, whereas in biogenic peptides or proteins the amide bond is always adjacent to aliphatic portions. It may further be of relevance that proteases exert a non-equal effect on strongly or less strongly crystalline areas.

As a first example according to the invention, 10 mM laccase (ThL, i.e. Trametes hirsuta, provided, e.g., as described in E. Almansa et al in “Biocatalytics and Biotransformation”, vol. 22, No. 5-6, pp. 315-324, January 2004) were added to the buffer solution, and the fibre structure was incubated in this buffer solution for 24 hours (temperature 25° C.; pH ranging between 3.5 and 3.7). Following incubation, there was carried out a further washing step as already described above, whereupon no laccase was detected anymore on the surface. For this example, there was given a degree of carboxylation of 0.45 nmol/mm², this is, already an increase of the areal density of the carboxyl groups. A suitable alternative laccase would be, for example, laccase from Myceliophtora thermophila, available from the manufacturer Novozyme, DK.

In a second example according to the invention there was added 1-HBT (20 mM) before the addition of the laccase ThL, with the incubation time and the subsequent washing step being carried out as in example 1.

For this example there was determined a degree of carboxylation of 0.91 nmol/mm². Hence, HBT acts as an additional disrupting molecule, which disrupts bonds of the individual chains of the aramid fibres at the surface in an aqueous solution and provides for a further increase of the areal density of the carboxyl groups, which cannot be obtained without additional disrupting agents (see example 1).

In a third exemplary embodiment, the process was like in the second example, however using TEMPO as a disrupting agent, also with 20 mM, as a disrupting molecule. Therein, there was obtained a degree of carboxylation of 0.80 nmol/mm².

The results of the examples 1, 2, and 3 as well as the zero-reference are again summarized in the table 1b below.

TABLE 1b

| Sample | DoC (nmol/mm²), TBO method |
|---|---|
| Zero-Reference | 0.11 |
| Example 1 | 0.45 |
| Example 2 | 0.91 |
| Example 3 | 0.80 |

A further measurement series confirmed these results, wherein as example 4 there was tested also VLA (40 mM) as a disrupting agent, with the results being represented in table 1c.

TABLE 1c

| Sample | DoC (nmol/mm²), TBO method |
|---|---|
| Zero-Reference | 0.11 |
| Example 1 | 0.45 |
| Example 2 | 0.91 |
| Example 3 | 0.74 |
| Example 4 | 0.54 |

A further experimental proof of the generation of additional hydrophilic functional groups on the surface was given by the fact that for the zero-reference in the measurement of the water contact angle (WCA, with Drop Shape Analysis System DSA 100 (Kruss GmbH, Germany), test fluid ddH₂O having a drop size of 5 μl and a dosage rate of 60 U min⁻¹), there could be determined a water drop absorption time of 2 seconds, whereas in comparison for the examples 2 and 3 the water drop absorption time was shorter (more or less immediate, very quick absorption) such that determination of the water contact angle according to common standard methods has not been possible anymore.

Samples of the zero-reference and of the examples 2, 3 and 4 were furthermore studied using scanning electron microscopy (Renishaw InVia Raman microscope having excitation lasers) in order to determine whether there may be detected a structural weakening of the single-aramid fibres because of surface treatment. This is not the case, as visible from the REM images of FIG. 1. FIG. 1a, for example, shows the REM image of the zero-reference, and FIG. 1b, FIG. 1c or FIG. 1d, respectively, show an REM image regarding the examples 2, 3 or 4, respectively.

As the structural integrity of the fibres is not affected by the surface treatment performed, there is also to be assumed that the mechanical properties will be maintained such that the reinforcement material will also be suitable for forming, for example, tyre cord, for which there are posed significant mechanical requirements.

In the following, the mechanism for increasing the areal density of the carboxyl groups will be again explained referring to a measurement of oxygen consumption. For this purpose, a fibre-optical oxygen sensor (Pyroscience, Aachen, Germany) was used. In the absence of oxygen, a luminance of an indicator dye (herein at 760-790 nm) will be suppressed by energy transfer, wherein the excess energy will be transferred to the oxygen molecules. The level of suppression thus corresponds to the oxygen concentration in the sample. As oxygen consumption determined in the measurement represents an indicator for the fact that there have been initiated oxidation processes on the aramid fibre surfaces, an effect based on an oxidation process may be determined using this method.

The oxygen level for a sample related to example 2 (buffer 100 mM, ThL 10 mM, HBT 20 mM, aramid fibre structure (70 mg)) initially decreases strongly over time as soon as laccase THL has been added, and this significantly stronger than in a blank comparison (example 2, but without aramid fibre structure substrate). Within the first three hours, there is recorded a maximum oxygen consumption, but after about 8 hours, the oxygen consumption decreased in relation to the blank reference. A further comparative reference, in which compared to example 2 there are contained only the disrupting agents (HBT) besides the buffer and the aramid fibre structure substrate, but not the laccase (THL), there cannot be detected any decrease of the oxygen level. In a third reference, in which compared to example 2 there are not contained any disrupting agents besides the buffer and the aramid fibre structure substrate, but rather laccase (THL), there was determined, in comparison to example 2, a markedly lower decrease of the oxygen level, which also recovered more quickly.

From this result may be drawn the conclusion that a relevant oxidation effect on the aramid fibre substrate is exerted by the disrupting molecules (e.g., HBT), which therein adopt a different chemical oxidation state and thus will not be available for any further disrupting effects, whereas the laccase (e.g., THL) alone may not effect disrupting mechanisms to this extent. The oxidative effect of the laccase targets the disrupting molecules, by completing a cyclic change of the state movement bringing them back to the state, in which they are able to effect further disruption for the aramid fibre substrate. For this reason, laccase represents a drive for the cyclic change of states of the disrupting agents. The disrupting molecules act as mediators of the oxidative effect.

In a similar manner, comparative oxygen measurements for another example with VLA as disrupting agent instead of HBT as disrupting agent were carried out. Also here, it was possible to detect that in the case of the blank reference, there could be determined oxygen consumption, due to the oxidation of the disrupting agents by the laccase. However, in the presence of the aramid fibre structure substrate the oxidative reaction was continued on the fibre surfaces. Accordingly, also the VLA proved to be a rather suitable candidate for the disrupting effect.

Furthermore, there were carried out performance tests according to ASTM D4393. Starting point of these performance tests was an aramid cord having 1670/2 dtex, Twist 350TPM. Upon washing steps as indicated above (with the exception of the treatment using TritonX-100), the enzymatic treatment was carried out again in several variants with a succinate buffer 100 mM. The further concentrations for the laccase used were 10 mM (ThL), and for the disrupting agents 20 mM respectively for HBT, TEMPO and VLA. In total, with 600 mL incubation solution, there was used a doses of 60 mL laccase and 120 mL of disrupting solution of 100 mM. The fibre structure parameters were about 20 m, surface of 390 cm² (estimation), with a weight of 7 to 9 g.

These samples were subjected to a standard RFL dipping procedure, and with the aramid cord samples thus dipped, there were carried out tests according to ASTM D4393. A further comparative reference was established without the surface treatment according to the invention but with the standard pre-dip before the proper RFL dip. A zero-reference was also formed, by only adding buffer solution but neither laccase nor disrupting agents. There was further determined the rupture strength according to ASTM D885-85 for the dipped aramid cord samples, wherein there is to be noted that there were observed measurement fluctuations of rupture strength values ranging from 13 to 20 N.

In the table 2 below there are indicated the measurement results for pull in N/cm, after 24 hours of conditioning. Furthermore, the table lists rupture strength values for the dipped aramid cord samples.

TABLE 2

| | Pull (N/cm) | Rupture strength (N) |
|---|---|---|
| Sample | (ASTM D4393) | (ASTM D885-85) |
| Zero-Reference | 91.5 | 490.0 |
| HBT | 96.6 | 505.7 |
| TEMPO | 107.0 | 491.3 |
| VLA | 100.5 | 493.0 |

Hence, there are visible significantly improved pull properties for all three types of the disrupting agents used; for TEMPO and VLA these are also significantly higher than in a comparative measurement with the pre-dip currently used in industry (comparative result here 98.1 N/cm).

The rupture strength values of the dipped cords with the aramid fibres modified according to the invention lie in the same range as the values, which are obtained for the zero-reference, or higher, respectively. There has also been shown that the mechanical properties of the underlying reinforcement material—as already has been indicated by way of optical investigation—are not being affected by the surface treatment realized. These results furthermore allow to conclusions regarding the tensile strength values of the reinforcement materials according to the invention. In order to obtain comparable rupture strengths for the dipped cords, the tensile strength values of the reinforcement materials according to the invention have to be within the range of the non-modified aramid fibres, this is, at least 600 MPa.

There may also be recognized improvements for coverage, even though these are less pronounced; herein, the best values may be obtained using the disrupting agent VLA, namely about 15% relative improvement in relation to the zero-reference.

The dip pick-up was between 8 and 9% for all examples, thus being on an acceptable level, only slightly higher than the comparative reference with industrial pre-dip.

The invention is not limited to the examples in the description above and the examples disclosed therein. The features of the claims below as well as of the preceding description may rather be essential, alone and in combination, for the realization of the invention in the various embodiments thereof.

1. A textile reinforcement material for reinforcing in particular rubber products, having at least one multi-fibre, which has aramid fibres having docking sites in the form of carboxyl groups arranged on the surface thereof for coupling in particular a rubber material,
characterized by an areal density of the docking sites of at least 0.2 nmol/mm² and a tensile strength of the multi-fibre of at least 600 MPa.

2. The textile reinforcement material according to claim 1, characterized in that the areal density of the docking sites is at least 0.4 nmol/mm², or at least 0.6 nmol/mm².

3. The textile reinforcement material according to claim 1, characterized in that the areal density of the docking sites is at most 2.4 nmol/mm², or at most 2.0 nmol/mm², or at most 1.6 nmol/mm².

4. The textile reinforcement material according to claim 1, characterized in that the tensile strength of the aramid fibres is at least 800 MPa, or at least 1000 MPa, or at least 1200 MPa.

5. The textile reinforcement material according to claim 1 having a water drop absorption time, determined according to the WCA test, of less than 1.6 s, or less than 1.2 s, or less than 0.8 s.

6. The textile reinforcement material according to claim 1, wherein in particular a majority of the docking sites is generated by a surface treatment resulting in a cleavage of amide bonds of the aramid fibres, which are near to the surface, by way of an oxidoreductase.

7. The textile reinforcement material according to claim 6, wherein a separating mechanism for disrupting the amide bonds has a disrupting agent alternating cyclically between at least two different adopted states, wherein this cyclic change of state is driven by the oxidoreductase in a partial cycle, the disrupting agent interacts oxidatively with the aramid fibres in another partial cycle respectively near an amide bond and/or a C₆ ring and wherein at least a part of the docking sites is generated from the amide bonds thus disrupted.

8. The textile reinforcement material according to claim 1 having a coating, which comprises in particular a rubber matrix, in which there is embedded a fibre structure containing the aramid fibres, wherein the coated reinforcement material is in particular tyre cord.

9. The textile reinforcement material according to claim 8 having a pull of at least 92 N/cm, determined according to ASTM D4393.

10. The textile reinforcement material according to claim 1 having further fibre components made from non-aramid fibres.

11. The textile reinforcement material according to claim 1 incorporated into a carcass and belt bandage material or reinforcement for conveyor belts or hoses.

12. A rubber product, in particular tyres, reinforced by a reinforcement material according to claim 1.

13. A method for preparing a structure containing fibres for the coupling thereof to in particular a rubber matrix, wherein the fibres have linear arrangements with at least in part aromatic segments, which are respectively connected to one another via amide bonds,
characterized in that at the surface of the fibres amide bonds are disrupted by a disruption mechanism including an oxidoreductase, in particular laccase, and thus, docking sites for the coupling of in particular the rubber matrix are generated from the disrupted amide bonds.

14. The method according to claim 13, wherein the disconnecting mechanism has a disrupting agent cyclically alternating between at least two different adopted states, wherein this cyclic change of state is driven by the oxidoreductase in a partial cycle and wherein in another partial cycle, respectively, the disrupting agent oxidizes the fibre near an amide bond and/or a C6 ring.

15. The method according to claim 14, wherein the disrupting agent is formed from one or several of substances contained in the group of HBT, VLA and TEMPO.

16. The method according to claim 13, wherein the disruption mechanism is realized in the absence of proteases.

17. A structure containing fibres, wherein the fibres have linear arrangements with at least in part aromatic segments, which are respectively connected to one another via amide bonds, and having fibre surfaces prepared according to claim 13 with additional docking sites for coupling the structure to a material to be coupled, in particular a rubber matrix.

18. An article having a fibre-containing structure according to claim 17 and a rubber matrix coupled at the docking sites thereof.

19. The textile reinforcement material according to claim 6, wherein the oxidoreductase is a laccase.
